(19) United States
(12) Patent Application Publication
(10) Pub. No.: US 2026/0307748 A1
(43) Pub. Date: Oct. 8, 2026

(54) TIRE COVER

(71) Applicant: Jie WANG, Fujian (CN)

(72) Inventor: Jie WANG, Fujian (CN)

(21) Appl. No.: 19/461,636

(22) Filed: Jan. 27, 2026

(51) Int. Cl. B62D 43/00

(52) U.S. Cl. CPC B62D 43/005

(57) ABSTRACT

A tire cover, having a protective cover body and a drawstring; a back panel of the protective cover body has a main back drawstring channel and an opening extending upwardly from a lower side of the back panel, two front drawstring channels are provided at a lower side of a front panel of the protective cover body; the drawstring passes through the main back drawstring channel and the two front drawstring channels; two free ends of the drawstring are located between the two front drawstring channels.

### BACKGROUND OF THE INVENTION

The present invention relates to the field of automobile accessories, and in particular, to a tire cover.

To protect automobile tires, people often install a tire cover on a automobile's tire (which may be mounted on the automobile's axle or a rear side of the automobile). The tire cover can provide protection against sunlight, wind, and dust.

An existing tire cover generally includes a soft cover body, which has a front panel, a back panel, and a side panel connecting the front cover and the back panel. The front panel is configured to cover a front surface of the tire, the side panel is configured to cover a side surface of the tire, and the back panel is configured to cover a back surface of the tire. A lower part of the back panel forms an opening to accommodate the axle. After the soft cover body of the existing tire cover is fitted over the tire, a bottom of the tire cover is generally secured using a rope, and the rope wraps around the bottom of the tire cover and a bottom of the tire. This method of securing the bottom of the tire cover is inconvenient to operate because the rope needs to wrap around the back of the tire. In addition, since the rope only secures the bottom of the tire cover, an upper half of the tire cover remains loose, which can cause the tire cover to be easily blown away by wind.

In view of the above issues, it is necessary to develop a tire cover that is easy to install and stable.

### BRIEF SUMMARY OF THE INVENTION

It is an object of the present invention to provide a tire cover that is easy to install and stable.

To achieve the above object, the present invention provides the following technical solutions:

A tire cover, comprising a protective cover body; the protective cover body comprises a front panel, a back panel, and a side panel that connects the front panel and the back panel; an opening is provided extending upwardly from a lower side of the back panel; wherein the tire cover also comprises a drawstring that fits with the protective cover body; two front drawstring channels are provided at a lower side of the front panel, and the two front drawstring channels are spaced apart from each other; the back panel is provided with a main back drawstring channel; the main back drawstring channel is positioned above the opening; the drawstring passes through the main back drawstring channel and the two front drawstring channels; two free ends of the drawstring are located between the two front drawstring channels.

The side panel is provided with two side drawstring channels; the two side drawstring channels are located on two sides of the side panel respectively; the drawstring passes through the two side drawstring channels.

The back panel is further provided with two auxiliary back drawstring channels; the two auxiliary back drawstring channels are located on two sides of the main back drawstring channel respectively, and being positioned lower than the main back drawstring channel; the two auxiliary back drawstring channels are inclined downwardly towards two opposite directions respectively, such that a horizontal spacing between the two auxiliary back drawstring channels gradually widens towards the lower side of the back panel; the drawstring also passes through the two auxiliary back drawstring channels.

The two side drawstring channels of the side panel are located at two opposite lower sides of the side panel respectively.

The two side drawstring channels of the side panel are arranged in an inclined manner, and for each of the two side drawstring channels, a first end proximal to the main back drawstring channel is positioned higher than a second end which is proximal to the front drawstring channel.

The main back drawstring channel of the back panel is located in a middle part of the back panel.

The two free ends of the drawstring are connected by a cord lock; the cord lock clamps the two free ends of the drawstring.

The two free ends of the drawstring are further tied up to form a knot.

A periphery of the opening of the back panel is fitted with an elastic cord.

The two front drawstring channels on the front panel are symmetrically arranged on two sides of a central axis of the front panel respectively.

When installing the tire cover of the present invention onto a tire, unfold the protective cover body, fits the protective cover body onto the tire, and then tightens the drawstring. The entire installation process is very simple. After tightening the drawstring, the drawstring can be tightened on the back panel and the lower side of the front panel, thus ensuring that the protective cover body can be stably fitted over the tire, thereby preventing the protective cover body from being blown away by wind.

### BRIEF DESCRIPTION OF THE DRAWINGS

FIG. 1 is a first schematic structural view of Embodiment I of the present invention.

FIG. 2 is a second schematic structural view of Embodiment I of the present invention.

FIG. 3 is a third schematic structural view of Embodiment I of the present invention.

FIG. 4 is a first schematic partial structural view of Embodiment I of the present invention.

FIG. 5 is a second schematic partial structural view of Embodiment I of the present invention.

FIG. 6 is a first schematic structural view of Embodiment II of the present invention.

FIG. 7 is a second schematic structural view of Embodiment II of the present invention.

FIG. 8 is a third schematic structural view of Embodiment II of the present invention.

FIG. 9 is a first schematic partial structural view of Embodiment II of the present invention.

FIG. 10 is a second schematic partial structural view of Embodiment II of the present invention.

### REFERENCE NUMERALS IN THE FIGURES

Protective cover body 1;
Front panel 11; Front drawstring channel 111;
Back panel 12; Opening 121; Elastic cord 1211; Main back drawstring channel 122; Auxiliary back drawstring channel 123;
Side panel 13; Side drawstring channel 131;
Drawstring 2; Free end 21; Knot 211;
Cord lock 3.

### DETAILED DESCRIPTION OF THE INVENTION

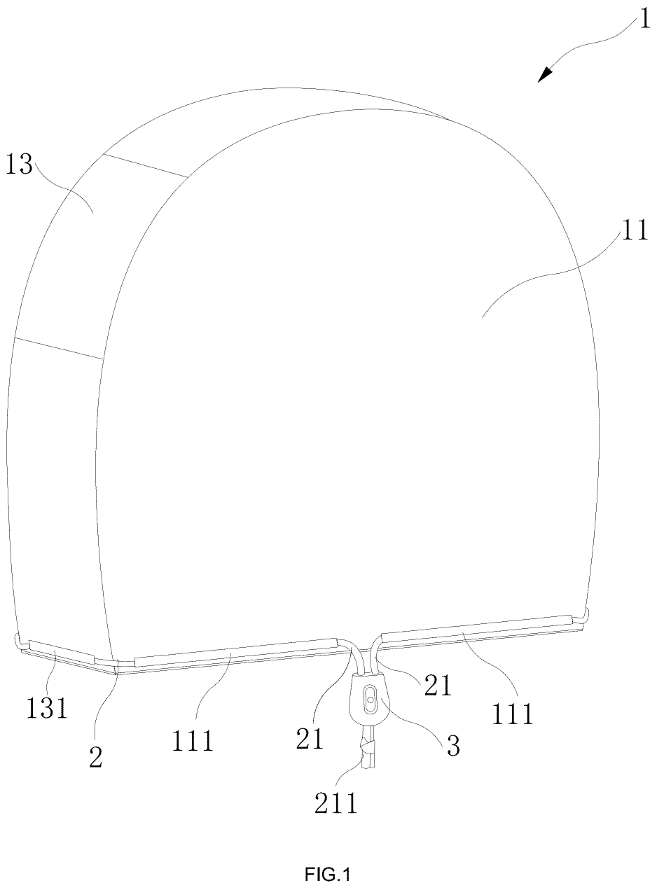

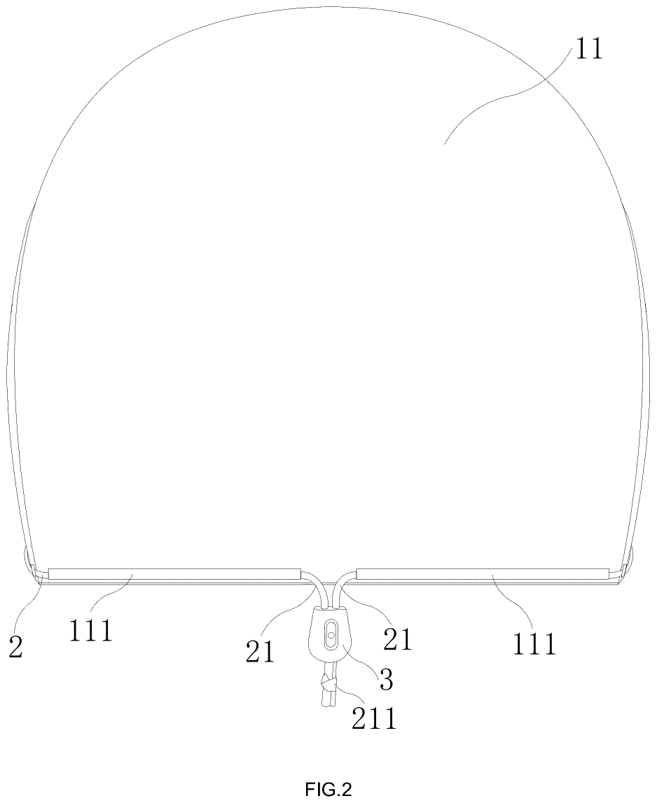

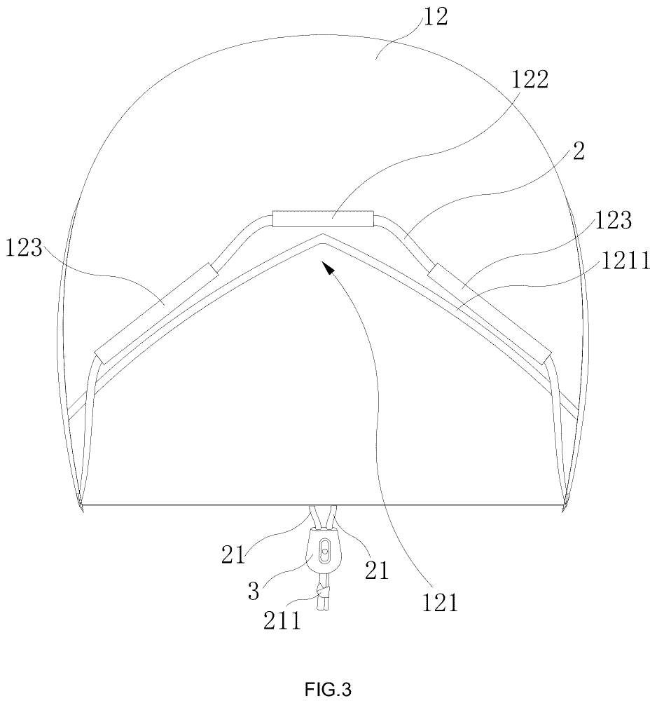

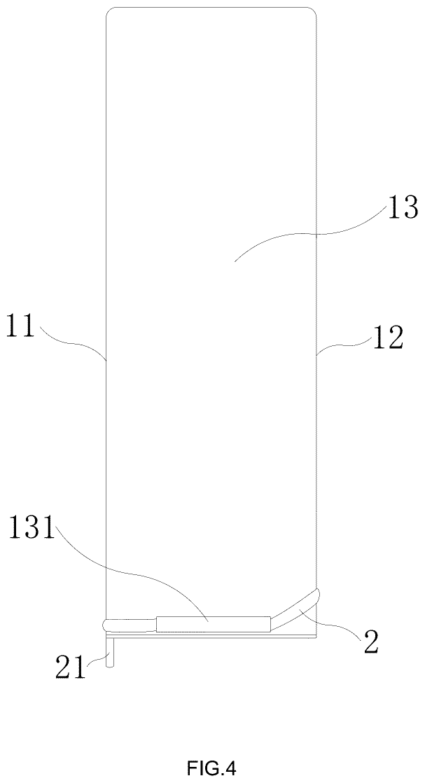

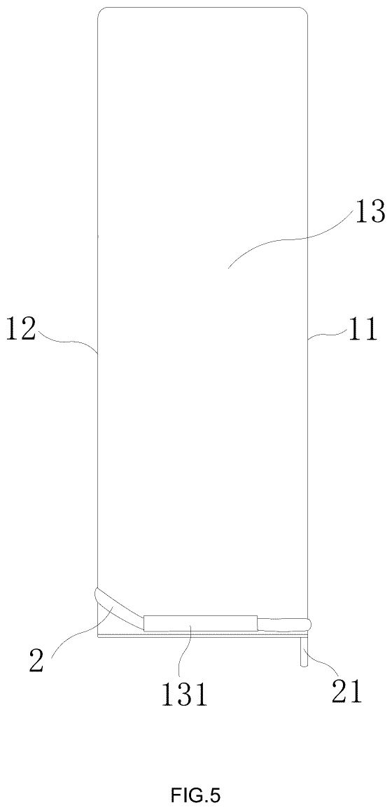

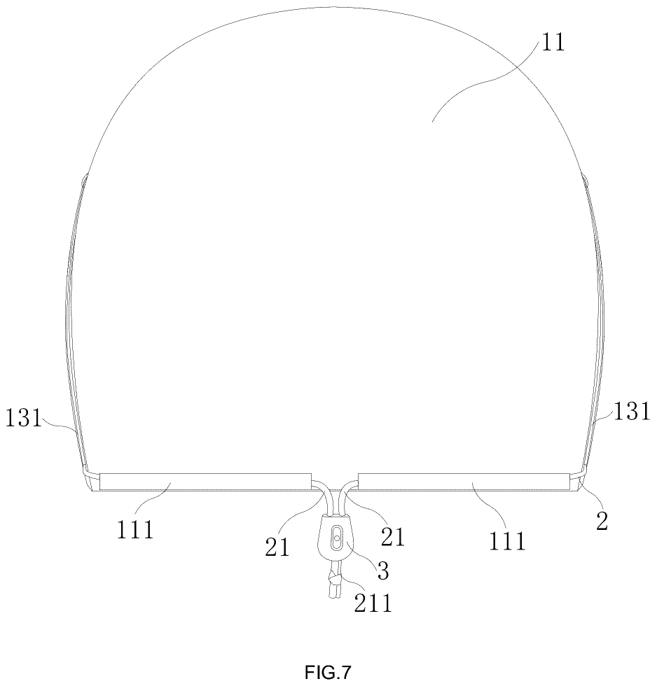

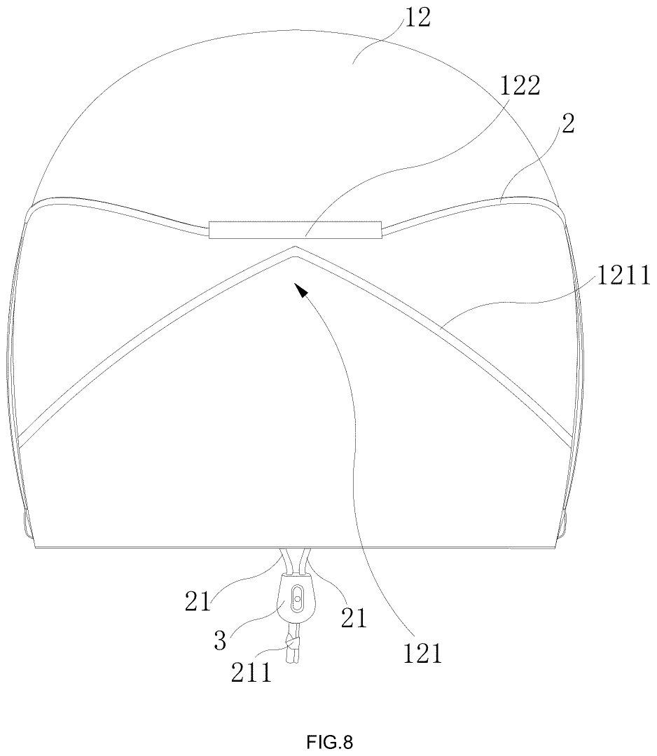

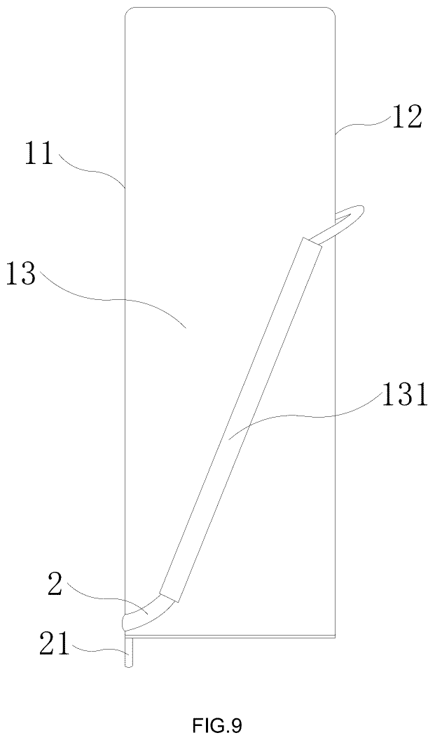

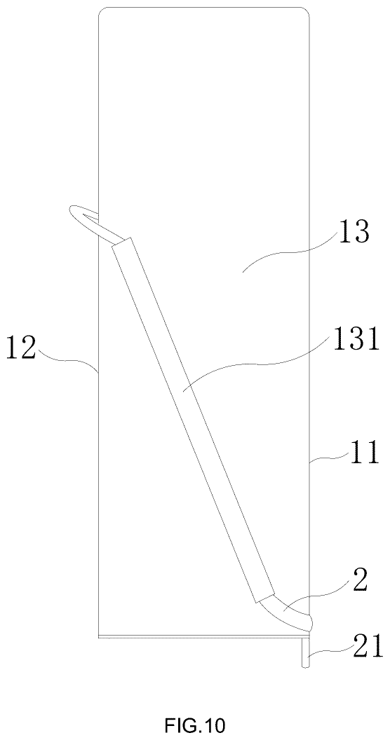

As shown in FIGS. 1 to 10, the present invention discloses a tire cover, which comprises a protective cover body 1 and a drawstring 2 that fits with the protective cover body 1; the protective cover body 1 comprises a front panel 11, a back panel 12, and a side panel 13 that connects the front panel 11 and the back panel 12; two front drawstring channels 111 are provided at a lower side of the front panel 11, and the two front drawstring channels 111 are spaced apart from each other; an opening 121 is provided extending upwardly from a lower side of the back panel 12; the back panel 12 is further provided with a main back drawstring channel 122; the main back drawstring channel 122 is positioned above the opening 121; the drawstring 2 passes through the main back drawstring channel 122 and the two front drawstring channels 111, and two free ends 21 of the drawstring 2 are located between the two front drawstring channels 111.

When installing the tire cover of the present invention onto a tire, unfold the protective cover body 1, fits the protective cover body 1 onto the tire, and then tightens the drawstring 2. The entire installation process is very simple. After tightening the drawstring 2, the drawstring 2 can be tightened on the back panel 12 and the lower side of the front panel 11, thus ensuring that the protective cover body 1 can be stably fitted over the tire, thereby preventing the protective cover body 1 from being blown away by wind.

To further explain the technical solutions of the present invention, a detailed description of the present invention is provided hereinafter through specific embodiments.

### Embodiment I

With reference to FIGS. 1 to 5, in Embodiment I of the present invention, the two front drawstring channels 111 on the front panel 11 are symmetrically arranged on two sides of a central axis of the front panel 11 respectively. In this way, the lower side of the front panel 11 is evenly tightened by the drawstring 2 and is less likely to be blown away by wind.

In Embodiment I of the present invention, the main back drawstring channel 122 of the back panel 12 is located in a middle part of the back panel 12. In this way, the drawstring 2 can be tightened on the middle part of the back panel 12, ensuring the tightening effect on the back panel 12. In addition, the back panel 12 is further provided with two auxiliary back drawstring channels 123; the two auxiliary back drawstring channels 123 are located on two sides of the main back drawstring channel 122 respectively, and being positioned lower than the main back drawstring channel 122. The two auxiliary back drawstring channels 123 are inclined downwardly towards two opposite directions respectively, such that a horizontal spacing between the two auxiliary back drawstring channels 123 gradually widens towards the lower side of the back panel 12, and the two auxiliary back drawstring channels 123 are arranged symmetrically; the drawstring 2 also passes through the two auxiliary back drawstring channels 123. In this way, the drawstring 2 can be tightened on the middle part as well as both sides of the back panel 12, thus enhancing the tightening effect on the back panel 12.

In Embodiment I of the present invention, a periphery of the opening 121 on the back panel 12 is fitted with an elastic cord 1211. In this way, the elastic force of the elastic cord 1211 can enable the protective cover body 1 to embrace the tire after the protective cover body 1 is fitted over the tire, thereby providing a temporary fixation effect for the protective cover body 1 when the drawstring 2 is not yet tightened.

In Embodiment I of the present invention, the side panel 13 is provided with two side drawstring channels 131; the two side drawstring channels 131 are located on two sides of the side panel 13 respectively, and the two side drawstring channels 131 are arranged symmetrically; the drawstring 2 passes through the two side drawstring channels 131. In this way, the drawstring 2 can be tightened on the side panel 13, thus further enhancing the stability of the protective cover body 1 when it is fitted over the tire. Specifically, the two side drawstring channels 131 of the side panel 13 are located at two opposite lower sides of the side panel 13 respectively. In this way, the drawstring 2 can be tightened on the lower sides of the side panel 13, thus further enhancing the tightening effect on the protective cover body 1.

In Embodiment I of the present invention, the two free ends 21 of the drawstring 2 are connected by a cord lock 3, with the cord lock 3 clamping the two free ends 21 of the drawstring 2. In this way, to tighten the drawstring 2, first, press and hold a button of the cord lock 3 to overcome a spring force of the button so as to release the clamping effect of the cord lock 3 on the two free ends 21 of the drawstring 2, then pull the two free ends 21 of the drawstring 2 tight, and finally release the button of the cord lock 3 so that the cord lock 3 resets and clamps the two free ends 21 of the drawstring 2. The entire operation to tighten the drawstring 2 is very convenient. To loosen the drawstring 2, simply press the button of the cord lock 3 to release the clamping effect of the cord lock 3 on the two free ends 21 of the drawstring 2. It should be noted that, the two free ends 21 of the drawstring 2 may also be connected without the cord lock 3. In the present invention, the drawstring 2 can be alternatively tightened by tangling the two free ends 21 of the drawstring 2 at a point of the drawstring 2 where tightening is needed.

In Embodiment I of the present invention, the two free ends 21 of the drawstring 2 are further tied up to form a knot 211. The knot 211 can prevent the two free ends 21 of the drawstring 2 from dangling around, and the knot 211 can also prevent the drawstring 2 from being withdrawn out of the front drawstring channel 111 and the cord lock 3.

### Embodiment II:

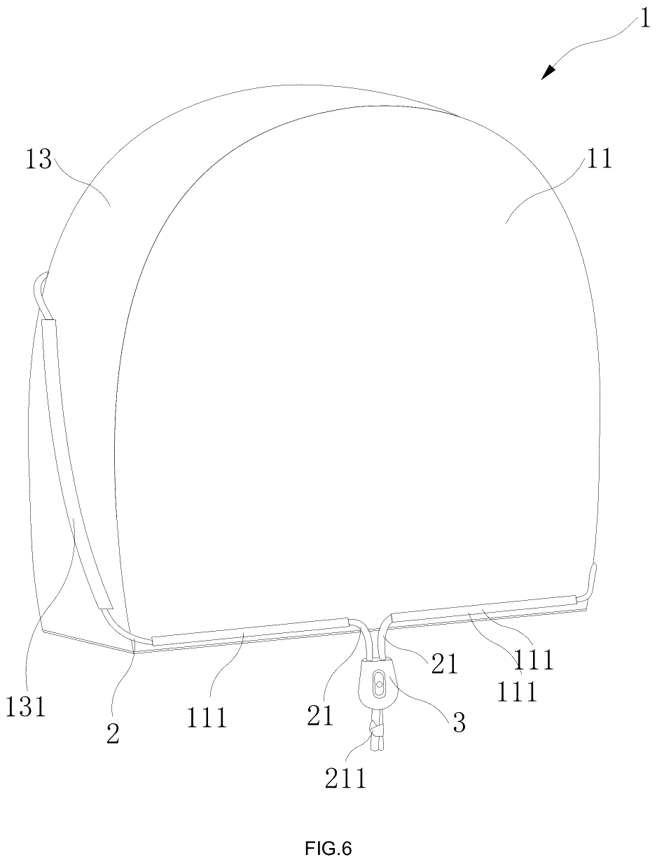

With reference to FIGS. 6 to 10, in Embodiment II of the present invention, the two front drawstring channels 111 on the front panel 11 are also symmetrically arranged on the two sides of the central axis of the front panel 11 respectively. In this way, the lower side of the front panel 11 is evenly tightened by the drawstring 2 and is less likely to be blown away by wind.

In Embodiment II of the present invention, the main back drawstring channel 122 of the back panel 12 is located in a middle part of the back panel 12. In this way, the drawstring 2 can be tightened on the middle part of the back panel 12, thus ensuring the tightening effect on the back panel 12. In addition, a periphery of the opening 121 of the back panel 12 is fitted with an elastic cord 1211. In this way, the elastic force of the elastic cord 1211 can enable the protective cover body 1 to embrace the tire after the protective cover body 1 is fitted over the tire, thereby providing a temporary fixation effect for the protective cover body 1 when the drawstring 2 is not yet tightened.

In Embodiment II of the present invention, the side panel 13 is provided with two side drawstring channels 131; the two side drawstring channels 131 are located on two sides of the side panel 13 respectively. The drawstring 2 passes through the two side drawstring channels 131. In this way, the drawstring 2 can be tightened on the side panel 13, thus further enhancing the stability of the protective cover body 1 when it is fitted over the tire. The two side drawstring channels 131 of the side panel 13 are arranged in an inclined manner, and for each of the two side drawstring channels 131, a first end proximal to the main back drawstring channel 122 is positioned higher than a second end which is proximal to the front drawstring channel 111.

In Embodiment II of the present invention, the two free ends 21 of the drawstring 2 are also connected by a cord lock 3, with the cord lock 3 clamping the two free ends 21 of the drawstring 2. In this way, to tighten the drawstring 2, first, press and hold a button of the cord lock 3 to overcome a spring force of the button so as to release the clamping effect of the cord lock 3 on the two free ends 21 of the drawstring 2, then pull the two free ends 21 of the drawstring 2 tight, and finally release the button of the cord lock 3 so that the cord lock 3 resets and clamps the two free ends 21 of the drawstring 2. The entire operation to tighten the drawstring 2 is very convenient. To loosen the drawstring 2, simply press the button of the cord lock 3 to release the clamping effect of the cord lock 3 on the two free ends 21 of the drawstring 2. It should be noted that the two free ends 21 of the drawstring 2 may also be connected without the cord lock 3. In the present invention, the drawstring 2 can also be alternatively tightened by tangling the two free ends 21 of the drawstring 2 at a point of the drawstring 2 where tightening is needed.

In Embodiment II of the present invention, the two free ends 21 of the drawstring 2 are further tied up to form a knot 211. The knot 211 can prevent the free ends 21 of the drawstring 2 from dangling around, and the knot 211 can also prevent the drawstring 2 from being withdrawn out of the front drawstring channel 111 and the cord lock 3.

The above embodiments and illustrations are not intended to limit the form and style of the product of the present invention. Any appropriate variations or modifications made by those of ordinary skill in the art shall be considered as falling within the scope of the patent of the present invention.

1. A tire cover, comprising a protective cover body; the protective cover body comprises a front panel, a back panel, and a side panel that connects the front panel and the back panel;
an opening is provided extending upwardly from a lower side of the back panel; wherein,
the tire cover also comprises a drawstring that fits with the protective cover body;
two front drawstring channels are provided at a lower side of the front panel, and the two front drawstring channels are spaced apart from each other; the back panel is provided with a main back drawstring channel; the main back drawstring channel is positioned above the opening;
the drawstring passes through the main back drawstring channel and the two front drawstring channels; two free ends of the drawstring are located between the two front drawstring channels.

2. The tire cover of claim 1, wherein the side panel is provided with two side drawstring channels; the two side drawstring channels are located on two sides of the side panel respectively; the drawstring passes through the two side drawstring channels.

3. The tire cover of claim 2, wherein the back panel is further provided with two auxiliary back drawstring channels; the two auxiliary back drawstring channels are located on two sides of the main back drawstring channel respectively, and being positioned lower than the main back drawstring channel; the two auxiliary back drawstring channels are inclined downwardly towards two opposite directions respectively, such that a horizontal spacing between the two auxiliary back drawstring channels gradually widens towards the lower side of the back panel;
the drawstring also passes through the two auxiliary back drawstring channels.

4. The tire cover of claim 3, wherein the two side drawstring channels of the side panel are located at two opposite lower sides of the side panel respectively.

5. The tire cover of claim 2, wherein the two side drawstring channels of the side panel are arranged in an inclined manner, and for each of the two side drawstring channels, a first end proximal to the main back drawstring channel is positioned higher than a second end which is proximal to the front drawstring channel.

6. The tire cover of claim 2, wherein the main back drawstring channel of the back panel is located in a middle part of the back panel.

7. The tire cover of claim 1, wherein the two free ends of the drawstring are connected by a cord lock; the cord lock clamps the two free ends of the drawstring.

8. The tire cover of claim 1, wherein the two free ends of the drawstring are further tied up to form a knot.

9. The tire cover of claim 1, wherein a periphery of the opening of the back panel is fitted with an elastic cord.

10. The tire cover of claim 1, wherein the two front drawstring channels on the front panel are symmetrically arranged on two sides of a central axis of the front panel respectively.
